(19) United States
(12) Patent Application Publication
(10) Pub. No.: US 2026/0138437 A1
(43) Pub. Date: May 21, 2026

(54) AUXILIARY DRIVING APPARATUS OF A 4WD HYBRID ELECTRIC VEHICLE

(71) Applicants: HYUNDAI MOTOR COMPANY, Seoul (KR); KIA CORPORATION, Seoul (KR)

(72) Inventors: Sung Gon Byun, Hwaseong-si (KR); Kwang Min Choi, Hwaseong-si (KR); Chonok Kim, Hwaseong-si (KR); Baekyu Kim, Hwaseong-si (KR); Won Seok Lee, Hwaseong-si (KR); Junyoung Ha, Hwaseong-si (KR); Su Hyeon Maeng, Hwaseong-si (KR); Dong Hui Cheon, Hwaseong-si (KR); Jieun Kim, Hwaseong-si (KR); Yohan Kim, Hwaseong-si (KR); Jaehyuk Seo, Hwaseong-si (KR); Jongho Jung, Hwaseong-si (KR); Yunkyung Ji, Hwaseong-si (KR); Jongyun Park, Hwaseong-si (KR); Sun Sung Kwon, Hwaseong-si (KR)

(73) Assignees: HYUNDAI MOTOR COMPANY, Seoul (KR); KIA CORPORATION, Seoul (KR)

(21) Appl. No.: 19/390,155

(22) Filed: Nov. 14, 2025

(30) Foreign Application Priority Data
Nov. 18, 2024 (KR) 10-2024-0163821

(51) Int. Cl. B60K 6/52; B60K 6/24; B60K 6/26; B60K 6/365; B60K 6/387; B60K 6/442

(52) U.S. Cl. CPC B60K 6/52; B60K 6/24; B60K 6/26; B60K 6/365; B60K 6/387; B60K 6/442; B60Y 2200/92; B60Y 2400/421; B60Y 2400/4244; B60Y 2400/43; B60Y 2400/60; B60Y 2400/80; B60Y 2400/82

(57) ABSTRACT

An auxiliary driving apparatus of a 4WD hybrid electric vehicle is a series-type driving apparatus to which a longitudinal engine is applied, and a driving mechanism including an engine, a motor, and a plurality of clutches is applied to the front wheel side of a hybrid electric vehicle with a motor applied to the rear wheel side as a main driving source, so that the series mode can be implemented in the rear wheel 2WD mode, and the 4WD (AWD) EV mode can be driven when the engine is stopped.

### CROSS-REFERENCE TO RELATED APPLICATION

This application claims the benefit of and priority to Korean Patent Application No. 10-2024-0163821, filed with the Korean Intellectual Property Office on Nov. 18, 2024, the entire contents of which are hereby incorporated herein by reference.

### BACKGROUND

### (a) Technical Field

The present disclosure relates to an auxiliary driving apparatus of a 4WD hybrid electric vehicle, and more particularly, relates to an auxiliary driving apparatus of an electric vehicle for a four-wheel drive applied to the front wheel side of a hybrid electric vehicle, where a motor is applied to the rear wheel side as a main driving source, and a series-type driving apparatus to which a longitudinal engine is applied.

### (b) Description of the Related Art

Environment-friendly technology in the vehicle field is a core technology that may determine the survival of the future vehicle industry, and vehicle manufacturers are making all-out efforts to develop environment-friendly vehicles to meet environmental and fuel efficiency regulations.

As part of environment-friendly vehicle, vehicle manufacturers are focusing on developing environment-friendly electric vehicles such as hybrid electric vehicle (HEV), plug-in hybrid electric vehicle (PHEV), pure electric vehicle (BEV: Battery Electric Vehicle), and fuel cell electric vehicle (FCEV).

Because environment-friendly vehicles have various technical constraints such as weight and cost, vehicle manufacturers are paying attention to electric vehicles as a realistic alternative to satisfy exhaust gas regulations and improve fuel efficiency performance, and are also competing fiercely in research and development of power delivery devices to put them into practice.

An environment-friendly vehicle provides torque using a motor as a power source, and then increases the torque through a reducer to provide driving torque to the vehicle, which can contribute to improving air pollution caused by existing pure internal combustion engine vehicles.

In the case of four-wheel drive (4WD) hybrid electric vehicles, the drive system is divided into in parallel type, power branch type, and series type. The parallel type is a system that adds a motor to a vehicle to which an existing gasoline engine is applied to minimize the torque and output of the motor. The engine power is directly transmitted to the drive shaft, and the motor power assists.

Additionally, the power branch type is a system that converts part of the engine power into two large motors and a planetary gear set and transmits it to the drive shaft.

FIG. 1 is a schematic view of the drive system of a typical serial type 4WD hybrid electric vehicle.

Referring to FIG. 1, the series type is a system optimized for the series mode that converts all power generated from an engine ENG into electricity through a second motor MG2, which is an auxiliary drive source for the front wheels, and then converts it into power through a first motor MG1, which is the main drive source for the rear wheels, to drive the vehicle.

In a hybrid electric vehicle of the serial type, the auxiliary driving apparatus applied to the front wheel side includes a disconnector system, and when driving in two-wheel device (2WD), the vehicle body and the auxiliary driving apparatus (motor and reducer, etc.) are separated to reduce the drag torque due to the electric power of the motor or the drag torque of the reducer, and a technology is applied to improve the fuel efficiency.

Accordingly, a series-type hybrid electric vehicle may implement a rear wheel 2WD driving EV mode by operating the disconnector applied to the auxiliary driving apparatus on the front wheel side in the series mode and disengaging it.

However, in order to implement 4WD (or all-wheel drive (AWD)) driving, the disconnector must be maintained in an operating state, so the engine ENG cannot be separated from the drive system (reducer, etc.). In particular, in 4WD driving EV mode where the engine ENG is stopped, there is a problem that the power efficiency is adversely affected due to the stationary load transferred from the engine ENG to the drivetrain (reduction gear, etc.).

The information contained in this background section is intended to enhance understanding of the background of the present disclosure and may include matters that are not conventional art already known to a person of ordinary skill in the art to which the present disclosure pertains.

### SUMMARY

Aspects of the present disclosure provide a an auxiliary driving apparatus of a series type to which a longitudinal engine is applied, and a driving mechanism including an engine, a motor, where a plurality of clutches is applied to the front wheel side of a hybrid electric vehicle with a motor applied to the rear wheel side as a main driving source, so as to enable implementation of a series mode in the rear wheel 2WD mode, and to enable driving in a 4WD (or AWD) EV mode with the engine stopped, thereby increasing fuel efficiency.

According to an embodiment, an auxiliary driving apparatus of a 4WD hybrid electric vehicle is provided. The 4WD hybrid electric vehicle includes a first motor applied to a rear wheel side as a main driving source, an engine and an auxiliary motor positioned in the longitudinal direction applied as an auxiliary driving source, where a motor torque output from the auxiliary motor is reduced in rotation speed by an auxiliary reducer and is transmitted to front wheels on two sides of the hybrid electric vehicle through an auxiliary differential configured to absorb a difference in rotation speed. The auxiliary motor includes an auxiliary motor shaft formed as a hollow shaft and arranged to overlap an engine output shaft of the engine without rotation interference. The auxiliary driving apparatus includes first and second idle shafts arranged parallel to the engine output shaft, and an output shaft arranged parallel to the second idle shaft and having power connected to the auxiliary differential via a front wheel transfer. The auxiliary reducer includes a first speed reducing part configured to selectively reduce rotation speed of an engine torque of the engine to the auxiliary motor through the engine output shaft, the idle shaft, and the auxiliary motor shaft. The auxiliary reducer also includes a second speed reducing part configured to selectively transmit the motor torque of the auxiliary motor to the front wheel transfer connected to a differential ring gear of the auxiliary differential through the auxiliary motor shaft, the second idle shaft, and the output shaft.

The first speed reducing part may include a first input gear fixed to the engine output shaft, a first idle gear rotatably arranged on the first idle shaft and externally engaged with the first input gear, a second idle gear which is fixed to the first idle shaft and externally engages a second input gear which is fixed to the auxiliary motor shaft, and a first clutch configured to selectively engage the first idle gear to the first idle shaft.

The first clutch may be a dog clutch provided between a first clutch dog fixed to the first idle shaft and a hub of the first idle gear. The first clutch may be a wet-type clutch provided between the first idle shaft and the first idle gear.

The second speed reducing part may include a second input gear fixed to the auxiliary motor shaft, an output gear fixed to the output shaft, a third idle gear rotatably disposed on the second idle shaft and externally engaged with the second input gear, a fourth idle gear fixed to the second idle shaft and externally engaged with the output gear, and a second clutch configured to selectively fix the third idle gear to the second idle shaft.

The second clutch may be a dog clutch provided between a second clutch dog fixed to the second idle shaft and a hub of the third idle gear. The second clutch may be a wet-type clutch provided between the second idle shaft and the third idle gear.

The second speed reducing part may include a second input gear fixed to the auxiliary motor shaft, an output gear fixed to the output shaft, a third idle gear fixed to the second idle shaft and externally engaged with the second input gear, a fourth idle gear which is fixed to the second idle shaft and externally engages an output gear which is rotatably arranged on the output shaft, and a second clutch configured to selectively fix the output gear to the output shaft.

The second clutch may be a dog clutch provided between a second clutch dog fixed to the output shaft and a hub of the output gear. The second clutch may be a wet-type clutch provided between the output shaft and the output gear.

The front wheel transfer may be a transfer shaft or a propeller shaft.

In 2WD EV mode EV1, a power delivery path of the second speed reducing part, through which the motor torque of the auxiliary motor is transmitted to the front wheel drive shaft, may be blocked. In 2WD series mode, a power delivery path of the first speed reducing part, through which the engine torque of the engine is transmitted to the auxiliary motor, may be connected.

In 4WD (AWD) EV mode EV2, a power delivery path of the second speed reducing part, where the torque of the auxiliary motor is transmitted to the front wheel drive shaft, may be connected.

The auxiliary driving apparatus of a 4WD hybrid electric vehicle according embodiments of the present disclosure includes an engine and a second motor arranged in a longitudinal direction on a front wheel side of a series-type hybrid electric vehicle that uses a first motor applied to a rear wheel side as a main driving source, so that the influence of drag torque generated from the second motor or a second reducer may be eliminated by disengaging the second clutch.

In the auxiliary driving apparatus of a 4WD hybrid electric vehicle according to embodiments of the present disclosure, a first clutch is operated to convert all driving torque generated from the engine into electricity through the second motor, which is the auxiliary driving source on the front wheel side, and then convert it into power through the first motor, which is the main driving source on the rear wheel side, to drive the vehicle, thereby enabling the implementation of a series mode.

In an auxiliary driving apparatus of a 4WD hybrid electric vehicle according to embodiments of the present disclosure, by operating the first and second clutches, it is possible to increase power efficiency by enabling 4WD (AWD) EV mode driving while the engine is stopped.

In addition, other effects that may be obtained or expected according to embodiments of the present disclosure are directly or implicitly disclosed in the detailed description that follows.

### BRIEF DESCRIPTION OF THE DRAWINGS

Because the accompanying drawings are merely provided for reference to describe embodiments of the present disclosure, the technical ideas of the present disclosure should not be interpreted as being limited by the accompanying drawings.

FIG. 1 is a schematic view of the drive system of a typical serial type 4WD hybrid electric vehicle.

FIG. 2 is a schematic diagram of an auxiliary driving apparatus of a 4WD hybrid electric vehicle according to an embodiment of the present disclosure.

FIG. 3 is an operational chart of driving methods of an auxiliary driving apparatus of a 4WD hybrid electric vehicle according to an embodiment of the present disclosure.

FIGS. 4 and 5 are operation state diagrams of an auxiliary driving apparatus of a 4WD hybrid electric vehicle in a 2WD series mode and a 4WD EV mode according to an embodiment of the present disclosure.

FIG. 6 is a schematic diagram of an auxiliary driving apparatus of a 4WD hybrid electric vehicle according to another embodiment of the present disclosure.

FIG. 7 is a schematic diagram of an auxiliary driving apparatus of a 4WD hybrid electric vehicle according to yet another embodiment of the present disclosure.

FIG. 8 is a schematic diagram of an auxiliary driving apparatus of a 4WD hybrid electric vehicle according to still another embodiment of the present disclosure.

FIG. 9 is a schematic diagram of an auxiliary driving apparatus of a 4WD hybrid electric vehicle according to yet another embodiment of the present disclosure.

FIG. 10 is a schematic diagram of an auxiliary driving apparatus of a 4WD hybrid electric vehicle according to still another embodiment of the present disclosure.

FIG. 11 is a schematic diagram of an auxiliary driving apparatus of a 4WD hybrid electric vehicle according to yet another embodiment of the present disclosure.

FIG. 12 is a schematic diagram of an auxiliary driving apparatus of a 4WD hybrid electric vehicle according to an embodiment of the present disclosure.

The drawings referenced above are not necessarily to scale, but should be understood as presenting rather simplified representations of various features illustrating the basic principles of the present disclosure. For example, certain design features of the present disclosure, including particular dimensions, direction, position, and shape, will be determined in part by the particular intended application and usage environment.

### DETAILED DESCRIPTION

Hereinafter, embodiments disclosed of the present disclosure are described in detail with reference to the accompanying drawings. It should be noted that identical or similar components are designated by the same or similar reference numerals and redundant descriptions thereof have been omitted.

In the following description, where it was determined that a detailed description of related known technology would obscure the gist of the present disclosure, the detailed description thereof has been omitted. In addition, the accompanying drawings are merely intended to facilitate understanding of the embodiments described in this specification, and the technical ideas disclosed in this specification are not limited by the accompanying drawings. Rather, the present disclosure should be understood to include all modifications, equivalents, or substitutes included in the spirit and technical scope of the present disclosure.

Terms that include ordinal numbers, such as first, second, etc., may be used to describe various configurations of elements, but the components are not limited by the terms. The terms are used solely to distinguish one component from another.

When a component is said to be “connected to” or “combined with” another component, it should be understood that the component may be directly connected to or combined with the other component, but there may also be one or more further components therebetween. On the other hand, when a component is said to be “directly connected to” or “directly combined with” another component, it should be understood that there are no other components in between.

In the present specification, it should be understood that terms such as “include”, “have”, “comprise”, or the like, are intended to specify the presence of a feature, number, step, operation, component, part or combination thereof described in the specification, but do not exclude the possibility of the presence or addition of one or more other features, numbers, steps, operations, components, parts or combinations thereof.

Terms such as “unit”, “portion”, “part”, “module”, and “means” described in the specification are assigned or used interchangeably only for the convenience of writing the specification, and do not have distinct meanings or roles in themselves. Terms such as “unit”, “portion”, “part”, “module”, and “means” described in the specification may mean a unit that processes at least one function or operation, and this may be implemented by hardware, software, or a combination of hardware and software.

As used herein, the singular forms are intended to include the plural forms as well, unless the context clearly indicates otherwise. As used herein, the term “and/or” includes any one or all combinations of the associated listed items.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

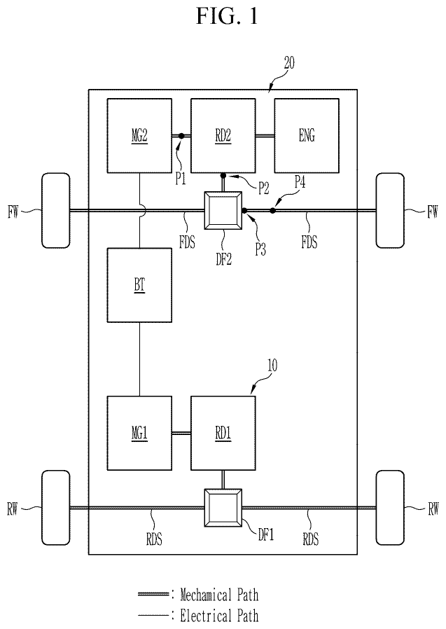

Hereinafter, embodiments of the present disclosure are described in more detail with reference to FIGS. 1-12.

For reference, symbols in FIGS. 1-12 are as follows.

### DESCRIPTION OF SYMBOLS

10: rear wheel side driving apparatus (main driving apparatus)
20: front wheel side driving apparatus (auxiliary driving apparatus)
ENG: engine
EOS: engine output shaft
MG1, MG2: first, second motor
RD1, RD2: first, second reducer
FW: front wheel
RW: rear wheel
FDS: front wheel drive shaft
RDS: rear wheel drive shaft
FTS: front wheel transfer
OS: output shaft
OG: output gear
RP1, RP2: first, second speed reducing part
C1, C2: first, second clutch
IG1, IG2; first, second input gear
IDS1, IDS2: first, second idle shaft
IDG1, IDG2, IDG3, IDG4: first, second, third, fourth idle gear
DF1, DF2: first, second differential
DFR: differential ring gear
DFC: differential case
PS: pinion shaft
PG: pinion gear
SG: side gear
BT: battery

FIG. 1 is a schematic view of a drive system of a typical serial type 4WD hybrid electric vehicle.

Referring to FIG. 1, a drive system of a typical 4WD hybrid electric vehicle includes a rear wheel-side driving apparatus 10 (i.e., a main driving apparatus) including a first motor MG1, a first reducer RD1, and a first differential DF1 provided on a rear wheel RW side and transmitting power to the left and right rear wheels RW through left and right rear wheel drive shafts RDS. The 4WD hybrid electric vehicle also includes a front wheel-side driving apparatus 20 (i.e., an auxiliary driving apparatus) including an engine ENG, a second motor MG2, a second reducer RD2, and a second differential DF2 provided on a front wheel FW side and transmitting power to the left and right front wheels FW through left and right front wheel drive shafts FDS. The 4WD hybrid electric vehicle additionally includes a battery BT supplying power to the first and second motors MG1 and MG2.

The first and second motors MG1, MG2 generate output torque by controlling the rotating direction and rotation speed (RPM) under the control of MCU (Motor Control Unit). The first motor MG1 provides power to the left and right rear wheels RW, and the second motor MG2 provides power to the left and right front wheels FW.

These first and second motors MG1 and MG2 may also be used as generators to charge battery BT by generating counter electric power when the battery's state of charge (SOC) is low or during regenerative braking.

The first and second reducers RD1, RD2 are a type of transmission that reduces rotation speed and transmits the power generated from the first and second motors MG1, MG2 to the corresponding wheels RW FW, respectively. The first reducer RD1 controls the rotation speed (motor torque) of the first motor MG1 and transmits the motor torque to the left and right rear wheels RW. The second reducer RD2 controls the rotation speed (motor torque) of the second motor MG2 and transmits the motor torque to the left and right front wheels FW.

The first and second differentials DF1, DF2 are connected to the first and second reducers RD1, RD2, respectively, and transmit the output torque of the first and second reducers RD1 and RD2 to the corresponding wheels RW and FW. The first reducer RD1 transmits the power generated from the first motor MG1 while absorbing the difference in rotation speed between the left and right rear wheels RW. The second reducer RD2 transmits the power generated from the second motor MG2 while absorbing the difference in rotation speed between the left and right front wheels FW.

The drive system of a 4WD hybrid battery vehicle having such a configuration operates the rear wheel side as the main drive wheel and the front wheel side as the auxiliary drive wheel, so that when driving in 4WD (or AWD), both the rear wheel side driving apparatus 10 and the front wheel side driving apparatus 20 are driven to transmit power to the rear wheel RW and the front wheel FW, respectively. On the other hand, when driving in 2WD, only the rear wheel side driving apparatus 10 is driven to transmit power to the rear wheel RW, and power is cut off to the front wheel FW.

The driving system of a typical 4WD hybrid electric vehicle illustrated in FIG. 1 is described as a reference for understanding the auxiliary driving apparatus of a 4WD hybrid electric vehicle according to embodiments of the present disclosure.

As used herein, the term “4WD” hybrid electric vehicle may refer to any hybrid electric vehicle having four or more wheels, provided that at least two wheels at the front and at least two wheels at the rear are driven, and includes systems that may also be referred to as all-wheel drive (AWD).

In explaining the auxiliary driving apparatus of a 4WD hybrid electric vehicle according to embodiments of the present disclosure, a repeated explanation of the same configuration as the driving system of the 4WD hybrid electric vehicle illustrated in FIG. 1 is omitted.

Referring to FIG. 1, the front wheel side driving apparatus 20, which is an auxiliary driving apparatus 20 of a 4WD hybrid electric vehicle according to an embodiment of the present invention, may connect or cut off power of the second motor MG2 to the left and right front wheels FW through a clutch or the like that functions as a disconnector.

The clutch or the like that functions as the disconnector may be installed on one side P1 of the second motor shaft MS2 to which power of the second motor MG2 is directly transmitted, or on one side P2 of the second reducer RD2, or on one side P3 of the second differential DF2, or on one side P4 of the front wheel drive shaft FDS.

The clutch or the like that performs the function of the disconnector may be installed at any one or more of four locations, P1, P2, P3, and P4, in the driving apparatus 20 on the front wheel side of the auxiliary driving wheel, and there is a difference in the power ratio, engage impact, engage time, etc. depending on the installation position.

In an embodiment, in the P1 and P2 positions, there may be no issues with engage impact or engage time, but they may be disadvantageous in terms of power efficiency. On the other hand, in the P3 and P4 positions, they may be advantageous in terms of power efficiency, but there may be issues with engage impact or engage time.

Referring to FIG. 1, an embodiment of the present disclosure is described as an example in which an auxiliary driving apparatus 20 of a 4WD hybrid electric vehicle is applied to a front wheel FW side, which is an auxiliary driving wheel, and a clutch is installed on one side P2 of a second reducer RD2 of the driving apparatus 20 on the front wheel side.

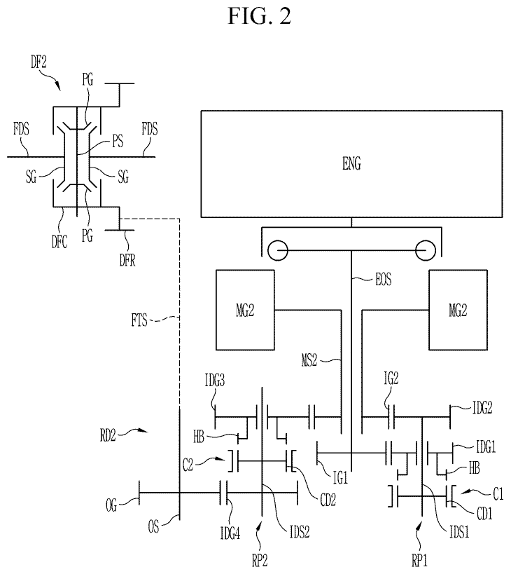

FIG. 2 is a schematic diagram of an auxiliary driving apparatus of a 4WD hybrid electric vehicle according to an embodiment of the present disclosure.

Referring to FIG. 2, hereinafter, an auxiliary driving apparatus 20 of a 4WD hybrid electric vehicle according to an embodiment of the present disclosure is described with reference to examples in which the auxiliary driving wheel is the front wheel FW, and some components not shown in FIG. 2 are expressed without distinguishing between the front wheel FW side and the rear wheel RW side. The components may be expressed as differential case DFC, differential ring gear DFR, pinion shaft PS, pinion gear PG, side gear SG, etc.

The auxiliary driving apparatus 20 includes a second motor MG2, an engine ENG, a second differential DF2, first, second idle shafts IDS1, and IDS2, an output shaft OS, and a second reducer RD2 including first and second speed reducing parts RP1 and RP2.

In describing the auxiliary driving apparatus 20 according to embodiments of the present disclosure, the first motor MG1, the first motor shaft MS1, the first reducer RD1, the first differential DF1 on the driving wheel side and the second motor MG2, the second motor shaft MS2, the second differential DF2, the second reducer RD2 on the auxiliary driving wheel side are described separately. According to embodiments, second motor MG2, second motor shaft MS2, second differential DF2, and second reducer RD2 may be understood as auxiliary motor MG2, auxiliary motor shaft MS2, auxiliary differential DF2, and auxiliary reducer RD2, respectively.

The engine ENG is configured as a longitudinally mounted engine placed on the front wheel FW side, which is an auxiliary driving wheel, to provide torque to the second motor MG2.

The second motor MG2 is arranged in the longitudinal direction on the front wheel FW side, and a second motor shaft MS2 is formed as a hollow shaft and is arranged to overlap with an engine output shaft EOS of the engine ENG without rotation interference to output torque.

The second differential DF2 is provided between the front wheel drive shafts FDS on both sides of the front wheel FW to absorb the difference in rotation speed of the front wheels FW on both sides and transmit the torque of the second motor MG2 to the front wheel drive shafts FDS on both sides.

In an embodiment, the second differential DF2 transmits the torque input from the second reducer RD2 to a differential ring gear DFR connected to a differential case DFC through a side gear SG that revolves with a pinion gear PG on a pinion shaft PS, through front wheel drive shafts FDS on both sides, to the front wheels FW on both sides. The differential function is performed by absorbing the difference in rotation speed of the front wheels FW on both sides by the rotation of the pinion gear PG.

The first and the second idle shafts IDS1, IDS2 are arranged parallel to the engine output shaft EOS, and the output shaft OS is arranged parallel to the second idle shaft IDS2 and is powered and connected to the second differential DF2 through a front wheel transfer FTS.

The second reducer RD2 includes a first speed reducing part RP1 that reduces rotation speed of the torque input from the engine ENG through first and second idle gears IDG1 and IDG2 on the first idle shaft IDS1 arranged parallel to the engine output shaft EOS of the engine ENG and outputs the torque to the second motor MG2. A second speed reducing part RP2 that reduces rotation speed of the torque input from the second motor MG2 and outputs the toque to the second differential DF2 through third and fourth idle gears IDG3 and IDG4 on the second idle shaft IDS2, which is arranged parallel to the engine output shaft EOS of the engine ENG, and the output gear OG on the output shaft OS, which is arranged parallel to the second idle shaft IDS2.

The first speed reducing part RP1 includes the first input gear IG1, the first idle gear IDG1, the second idle gear IDG2, and the first clutch C1.

The first input gear IG1 may be fixed to the engine output shaft EOS and may rotate together with the engine output shaft EOS. The first idle gear IDG1 may be rotatably arranged on the first idle shaft IDS1 and may externally engage the first input gear IG1.

The second idle gear IDG2 may be fixed to the first idle shaft IDS1 and may externally engage the second input gear IG2, which is fixed to the second motor shaft MS2.

The first clutch C1 is configured to selectively fix the first idle gear IDG1 to the first idle shaft IDS1. The first clutch C1 may be formed of a dog clutch provided between the first clutch dog CD1 fixed to the first idle shaft IDS1 and a hub HB of the first idle gear IDG1.

The first clutch C1 may be configured on the first idle shaft IDS1 together with the first idle gear IDG1 of the first speed reducing part RP1 to selectively transmit or block the torque of the engine ENG to the second motor MG2.

The first and second input gears IG1 and IG2 may have gear ratios set to reduce rotation speed of the torque of the engine ENG and transmit the torque to the second motor MG2 together with the first speed reducing part RP1.

The second speed reducing part RP2 includes the second input gear IG2, the output gear OG, the third idle gear IDG3, the fourth idle gear IDG4, and a second clutch C2.

The second input gear IG2 may be fixed to the second motor shaft MG2 and may rotate together with the second motor shaft MS2. The output gear OG may be rotatably positioned on the output shaft OS and may rotate together with the output shaft OS.

The third idle gear IDG3 may be rotatably positioned at the second idle shaft IDS and may externally engage with the second input gear IG2. The fourth idle gear IDG4 may be fixed to the second idle shaft IDS2 and may externally engage with the output gear OG.

The second clutch C2 is configured to selectively fix the third idle gear IDG3 to the second idle shaft IDS2. The second clutch C2 may be formed of a dog clutch provided between the second clutch dog CD2 fixed to the second idle shaft IDS2 and a hub HB of the third idle gear IDG3.

The second clutch C2 may be configured on the second idle shaft IDS2 together with the third idle gear IDG3 of the second speed reducing part RP2 to selectively transmit or block the torque of the second motor MG2 to the second differential DF2.

The front wheel transfer FTS may be a transfer shaft or a propeller shaft configured inside a transfer housing.

Hereinafter, the operation of the auxiliary driving apparatus of a 4WD hybrid electric vehicle, according to embodiments of the present disclosure, is described for different driving methods and modes.

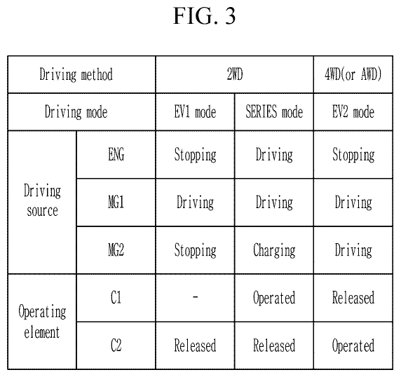

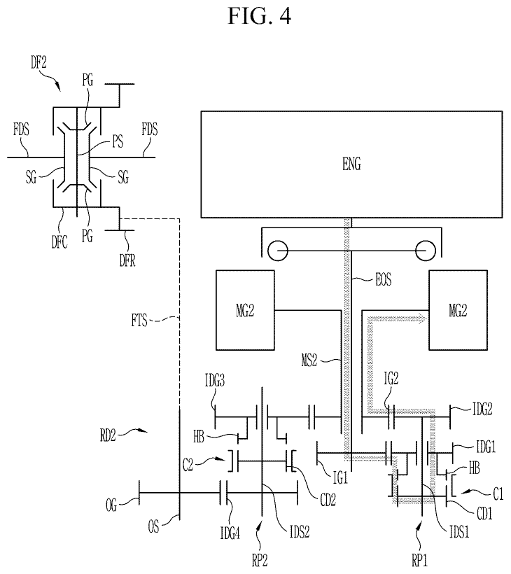

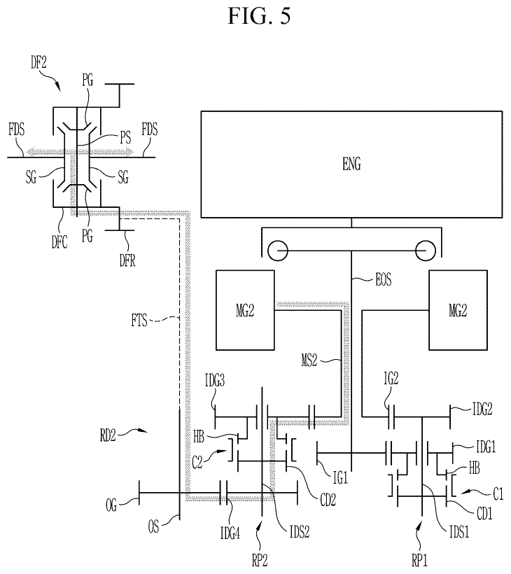

FIG. 3 is an operational chart of driving methods of an auxiliary driving apparatus of a 4WD hybrid electric vehicle according to an embodiment of the present disclosure. FIGS. 4 and 5 are operation state diagrams of an auxiliary driving apparatus of a 4WD hybrid electric vehicle in a 2WD series mode and a 4WD EV mode according to an embodiment of the present disclosure.

Before explaining the operation of the auxiliary driving apparatus 20 according to an embodiment of the present disclosure, it is noted that, according to an embodiment, the auxiliary driving apparatus 20 may be applied and operated on the front wheel FW side, which is an auxiliary driving wheel of a 4WD hybrid electric vehicle, and may be operated in a 2WD driving mode and a 4WD driving mode depending on the driving method.

The auxiliary driving apparatus 20 according to an embodiment of the present disclosure transmits the torque of the second motor MG2 to the front wheel FW side only when driving in 4WD, and when driving in 2WD, the power delivery path between the second motor MG2 and the front wheel FW is blocked by releasing the operation of the disconnector DC, thereby controlling them not to be connected.

### 2WD EV Mode EV1 Driving

Referring to FIG. 3, when driving in 2WD EV mode EV1, the engine ENG and second motor MG2 on the front wheel FW side are stopped, the second clutch C2 is released and the power delivery path through which the torque of the second motor MG2 is transmitted to the front wheel drive shaft FDS is blocked.

The first motor MG1 on the rear wheel RW side drives in the 2WD EV mode EV1.

It may be advantageous for the first clutch C1 to be remained in operation state for the sake of comparison in series mode, regardless of whether it is in operation or not.

### 2WD Series Mode Driving

Referring to FIGS. 3 and 4, in the 2WD series mode, the engine ENG on the front wheel FW is driven, the second clutch (C2) remains disengaged in the same manner as in the 2WD EV mode EV1, and the first clutch C1 operates so that the torque of the engine ENG is transmitted to the first input gear IG1, the first and second idle gears IDG1 and IDG2, and the second input gear IG2. Further, the power delivery path of the first speed reducing part RP1 that reduces the rotation speed of the torque of the engine ENG and transmits the torque to the second motor MG2 on the front wheel FW side is connected so that the second motor MG2 generates power and charges the battery BT. The first motor MG1 on the rear wheel RW side operates in 2WD series mode using electricity from the battery BT.

### 4WD (Or AWD) EV Mode EV2 Driving

Referring to FIGS. 3 and 5, when driving in 4WD (AWD) EV mode EV2, the engine ENG on the front wheel FW side stops, the second motor MG2 is driven, the first clutch C1 is released from operation, and the second clutch C2 is operated.

Then, the torque of the second motor MG2 on the front wheel FW side is transmitted to the second differential DF2 through the second input gear IG2, the third, fourth idle gears IDG3, and IDG4, and the output gear OG. Further, the power delivery path of the second speed reducing part RP2 is connected to the front wheel transfer FTS, and the driving of the first motor MG1 on the rear wheel RW side is performed in 4WD EV mode EV2.

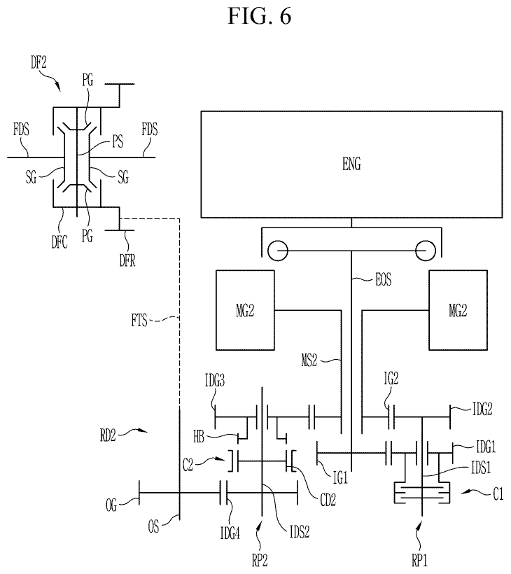

FIG. 6 is a schematic diagram of an auxiliary driving apparatus of a 4WD hybrid electric vehicle according to another embodiment of the present disclosure.

In the embodiment of FIG. 6, an auxiliary driving apparatus of a 4WD hybrid electric vehicle 20 has a difference in the type of the first clutch C1 compared to the embodiment of FIG. 2.

The first clutch C1 according to the embodiment of FIG. 2 is configured as the dog clutch provided between the first clutch dog CD1 fixed to the first idle shaft IDS1 and the hub HB of the first idle gear IDG1, whereas the first clutch C1 according to the embodiment of FIG. 6 may be configured as a wet-type clutch operated by hydraulic pressure, with a clutch disk and a clutch plate applied between the first idle shaft IDSs and the first idle gear IDG1.

The embodiment of FIG. 6 is different from the embodiment of FIG. 3 in the type of the first clutch C1, and the other configurations, operations and effects are the same, and are not described in detail in connection with FIG. 6 for the purpose of conciseness.

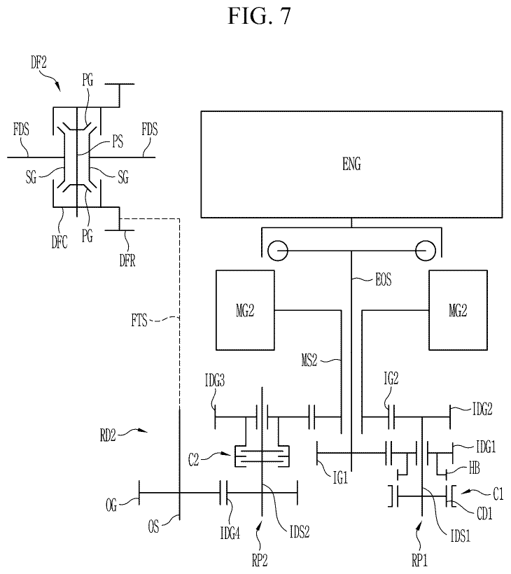

FIG. 7 is a schematic diagram of an auxiliary driving apparatus of a 4WD hybrid electric vehicle according to another embodiment of the present disclosure.

In the auxiliary driving apparatus of a 4WD hybrid electric vehicle 20 according to the embodiment of FIG. 7, there is a difference in the type of the second clutch C2 compared to the embodiment of FIG. 2.

The second clutch C2 according to the embodiment of FIG. 2 is configured as the dog clutch provided between the second clutch dog CD2 fixed to the second idle shaft IDS2 and the hub HB of the third idle gear IDG3, whereas the second clutch C2 according to the embodiment of FIG. 7 may be configured as a wet-type clutch applied with a clutch disk and a clutch plate between the second idle shaft IDS2 and the third idle gear IDG3 and operated by hydraulic pressure.

The embodiment of FIG. 7 is different only in the type of the second clutch C2 as compared to the embodiment of FIG. 2, and the other configurations, operations and effects are the same, and are described in detail in connection with FIG. 7 for the purpose of conciseness.

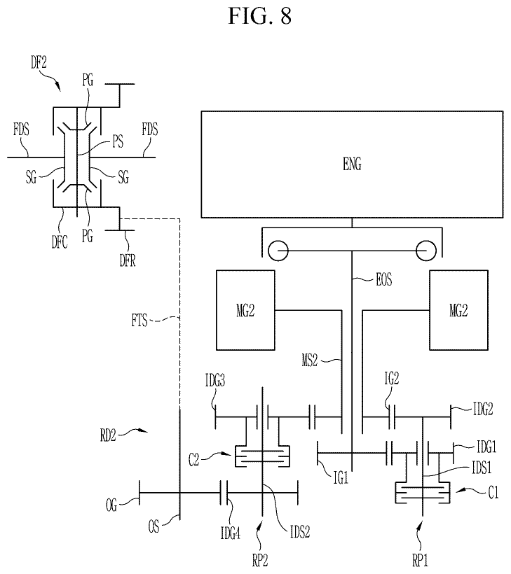

FIG. 8 is a schematic diagram of an auxiliary driving apparatus of a 4WD hybrid electric vehicle according to another embodiment of the present disclosure.

In the embodiment of the auxiliary driving apparatus of a 4WD hybrid electric vehicle 20 according to FIG. 8, there is a difference in the types of first and second clutches C1 and C2 compared to the embodiment of FIG. 2.

The first clutch C1 according to the embodiment of FIG. 2 includes the dog clutch provided between the first clutch dog CD1 fixed to the first idle shaft IDS1 and the hub HB of the first idle gear IDG1, and the second clutch C2 includes the dog clutch provided between the second clutch dog CD2 fixed to the second idle shaft IDS2 and the hub HB of the third idle gear IDG3, whereas the first clutch C1 according to the embodiment of FIG. 8 includes a wet-type clutch applied with a clutch disk and a clutch plate between the first idle shaft IDS1 and the first idle gear IDG1 and operated by hydraulic pressure, and the second clutch C2 includes a wet-type clutch applied with a clutch disk and a clutch plate between the second idle shaft IDS2 and the third idle gear IDG3 and operated by hydraulic pressure.

The embodiment of FIG. 8 is different only in the types of the first and second clutches C1 and C2 compared to the embodiment of FIG. 2, and the other configurations, operations and effects are the same, and are not described in detail in connection with FIG. 8 for the purpose of conciseness.

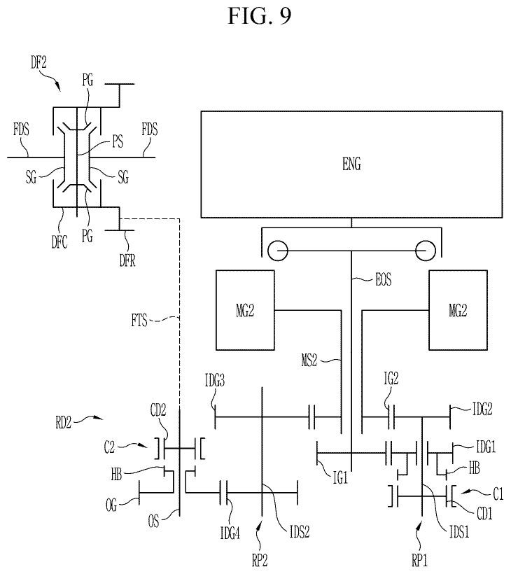

FIG. 9 is a schematic diagram of an auxiliary driving apparatus of a 4WD hybrid electric vehicle according to another embodiment of the present disclosure.

In an auxiliary driving apparatus of a 4WD hybrid electric vehicle 20 according to the embodiment of FIG. 9, there is a difference in the arrangement position of the second clutch C2 compared to the embodiment of FIG. 2.

The second clutch C2 according to the embodiment of FIG. 2 includes the dog clutch provided between the second clutch dog CD2 fixed to the second idle shaft IDS2 and the hub HB of the third idle gear IDG3, whereas the second clutch C2 according to the embodiment of FIG. 9 includes a dog clutch configured to selectively fix the output gear OG to the output shaft OS and includes a dog clutch provided between the second clutch dog CD2 fixed to the output shaft OS and the hub HB of the output gear OG.

The third idle gear IDG3 is fixed to the second idle shaft IDS2 and externally engages the second input gear IG2.

The embodiment of FIG. 9 is different only in the arrangement position of the second clutch C2 compared to the embodiment of FIG. 2, and the other configurations, operations and effects are the same, and are not described in detail in connection with FIG. 9 for the purpose of conciseness.

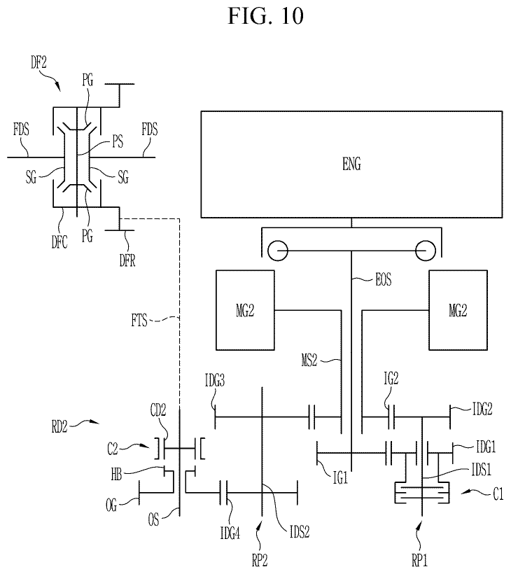

FIG. 10 is a schematic diagram of an auxiliary driving apparatus of a 4WD hybrid electric vehicle according to another embodiment of the present disclosure.

In the embodiment of FIG. 10, an auxiliary driving apparatus of a 4WD hybrid electric vehicle 20 has differences in the type of the first clutch C1 and the arrangement position of the second clutch C2 compared to the embodiment of FIG. 2.

The first clutch C1 according to the embodiment of FIG. 2 includes the dog clutch provided between the first clutch dog CD1 fixed to the first idle shaft IDS1 and the hub HB of the first idle gear IDG1, whereas the first clutch C1 according to the embodiment of FIG. 10 is a wet-type clutch operated by hydraulic pressure, with a clutch disk and a clutch plate applied between the first idle shaft IDS1 and the first idle gear IDG1.

Further, the second clutch C2 according to the embodiment of FIG. 2 includes the dog clutch provided between the second clutch dog CD2 fixed to the second idle shaft IDS2 and the hub HB of the third idle gear IDG3, whereas the second clutch C2 according to the embodiment of FIG. 10 is configured to selectively fix the output gear OG to the output shaft OS and is a dog clutch provided between the second clutch dog CD2 fixed to the output shaft OS and the hub HB of the output gear OG.

The third idle gear IDG3 is fixed to the second idle shaft IDS2 and externally engages the second input gear IG2.

The embodiment of FIG. 10 is different only in the type of the first clutch C1 and the position of the second clutch C2 compared to the embodiment of FIG. 2, and the other configuration, operation, and effects are the same, and are not described in detail in connection with FIG. 10 for the purpose of conciseness.

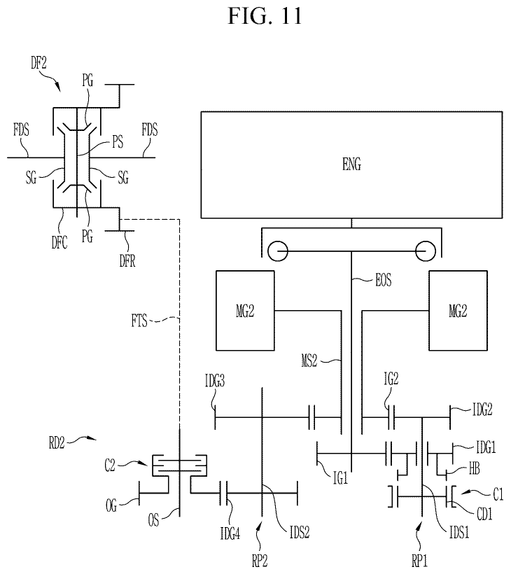

FIG. 11 is a schematic diagram of an auxiliary driving apparatus of a 4WD hybrid electric vehicle according to another embodiment of the present disclosure.

In the embodiment of FIG. 11, an auxiliary driving apparatus of a 4WD hybrid electric vehicle 20 has differences in the type and arrangement position of the second clutch C2 compared to the embodiment of FIG. 2.

The second clutch C2 according to the embodiment of FIG. 2 includes the dog clutch provided between the second clutch dog CD2 fixed to the second idle shaft IDS2 and the hub HB of the third idle gear IDG3, whereas the second clutch C2 according to the embodiment of FIG. 11 is configured to selectively fix the output gear OG to the output shaft OS, and is a wet-type clutch operated by hydraulic pressure, with a clutch disk and a clutch plate applied between the output shaft OS and the output gear OG.

The third idle gear IDG3 is fixed to the second idle shaft IDS2 and externally engages the second input gear IG2.

The embodiment of FIG. 11 is different only in the type and position of the second clutch C2 compared to the embodiment of FIG. 2, and other configuration, operation, and effects are the same, and are not described in detailed in connection with FIG. 11 for the purpose of conciseness.

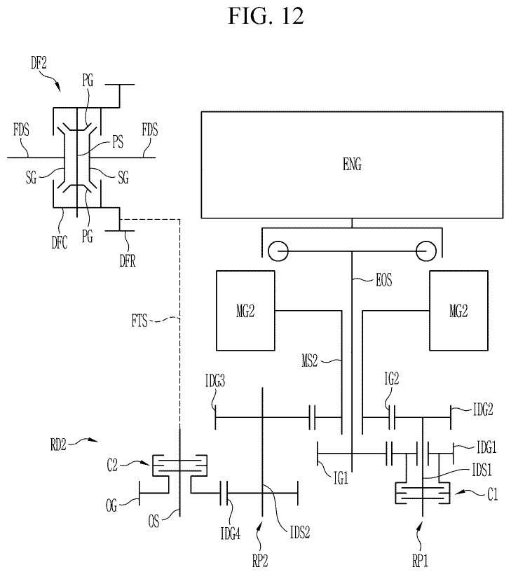

FIG. 12 is a schematic diagram of an auxiliary driving apparatus of a 4WD hybrid electric vehicle according to another embodiment of the present disclosure.

In an auxiliary driving apparatus of a 4WD hybrid electric vehicle 20 according to the embodiment of FIG. 12, there is a difference in the type of the first clutch C1 and the type and arrangement position of the second clutch C2 compared to the embodiment of FIG. 2.

The first clutch C1 according to the embodiment of FIG. 2 is configured as the dog clutch provided between the first clutch dog CD1 fixed to the first idle shaft IDS1 and the hub HB of the first idle gear IDG1, whereas the first clutch C1 according to the embodiment of FIG. 12 may be configured as a wet-type clutch operated by hydraulic pressure, with a clutch disk and a clutch plate applied between the first idle shaft IDSs and the first idle gear IDG1.

Further, the second clutch C2 according to the embodiment of FIG. 2 is configured as the dog clutch provided between the second clutch dog CD2 fixed to the second idle shaft IDS2 and the hub HB of the third idle gear IDG3, whereas the second clutch C2 according to the embodiment of FIG. 12 is configured to selectively fix the output gear OG to the output shaft OS, and may be formed as a wet-type clutch operated by hydraulic pressure with a clutch disk and a clutch plate between the output shaft OS and the output gear OG.

The third idle gear IDG3 is fixed to the second idle shaft IDS2 and externally engages the second input gear IG2.

The embodiment of FIG. 12 is different only in the type of the first clutch C1, the type of the second clutch C2, and the position thereof, compared to the embodiment of FIG. 2, and the other structure, operation, and effects are the same, and are not described in detailed in connection with FIG. 12 for the purpose of conciseness.

The auxiliary driving apparatus of a 4WD hybrid electric vehicle 20 according to embodiments of the present disclosure includes an engine ENG and a second motor MG2 arranged in a longitudinal direction on a front wheel FW side of a series-type hybrid electric vehicle that uses a first motor MG1 applied to the rear wheel RW side as a main driving source. The auxiliary driving apparatus includes first and second idle shafts IDS1, IDS2 and output shaft OS, and second reducer RD2 including first and second speed reducing parts RP1 and RP2, and the first and second clutches C1 and C2, and is applied as a driving mechanism so that the influence of drag torque generated from the second motor MG2 or the second reducer RD2 can be excluded by releasing the operation of the second clutch C2.

In the auxiliary driving apparatus of a 4WD hybrid electric vehicle 20 according to embodiments of the present disclosure, the first clutch C1 is operated to convert all driving torque generated from the engine ENG into electricity through the second motor MG2, which is the auxiliary driving source on the front wheel FW side, and then convert it into power through the first motor MG1, which is the main driving source on the rear wheel RW side, to drive the vehicle, thereby enabling the implementation of a series mode.

In an auxiliary driving apparatus of a 4WD hybrid electric vehicle 20 according to embodiments of the present disclosure, by operating the first and second clutches C1 and C2, it is possible to increase power efficiency by enabling 4WD (AWD) EV mode EV2 driving while the engine ENG is stopped.

Although the present disclosure has been described above with reference to example embodiments thereof, it should be understood by those having ordinary skill in the art that various modifications and changes may be made to described embodiments without departing from the spirit and scope of the present disclosure as set forth in the following claims.

What is claimed is:

1. An auxiliary driving apparatus for a front wheel side of a four-wheel drive (4WD) hybrid electric vehicle, the auxiliary driving apparatus comprising:
first and second idle shafts arranged in parallel to an engine output shaft, wherein the 4WD hybrid electric vehicle includes:
a first motor applied to a rear wheel side as a main driving source, and
an engine and an auxiliary motor positioned in a longitudinal direction and applied as an auxiliary driving source, wherein the auxiliary motor includes an auxiliary motor shaft formed as a hollow shaft and arranged to overlap the engine output shaft of the engine without rotation interference,
wherein a motor torque output from the auxiliary motor is reduced in rotation speed by an auxiliary reducer and the motor torque is transmitted to front wheels on two sides of the 4WD hybrid electric vehicle through an auxiliary differential while absorbing a difference in rotation speed; and
an output shaft arranged parallel to the second idle shaft and having power connected to the auxiliary differential via a front wheel transfer,
wherein the auxiliary reducer includes:
a first speed reducing part configured to selectively reduce rotation speed of an engine torque of the engine to the auxiliary motor through the engine output shaft, the second idle shaft, and the auxiliary motor shaft, and
a second speed reducing part configured to selectively transmit the motor torque of the auxiliary motor to the front wheel transfer connected to a differential ring gear of the auxiliary differential through the auxiliary motor shaft, the second idle shaft, and the output shaft.

2. The auxiliary driving apparatus of claim 1, wherein the first speed reducing part includes:
a first input gear fixed to the engine output shaft;
a first idle gear rotatably arranged on the first idle shaft and externally engaged with the first input gear;
a second idle gear which is fixed to the first idle shaft and externally engages a second input gear which is fixed to the auxiliary motor shaft; and
a first clutch configured to selectively engage the first idle gear to the first idle shaft.

3. The auxiliary driving apparatus of claim 2, wherein the first clutch comprises a dog clutch provided between a first clutch dog fixed to the first idle shaft and a hub of the first idle gear.

4. The auxiliary driving apparatus of claim 2, wherein the first clutch comprises a wet-type clutch provided between the first idle shaft and the first idle gear.

5. The auxiliary driving apparatus of claim 1, wherein the second speed reducing part includes:
a second input gear fixed to the auxiliary motor shaft;
an output gear fixed to the output shaft;
a third idle gear rotatably disposed on the second idle shaft and externally engaged with the second input gear;
a fourth idle gear fixed to the second idle shaft and externally engaged with the output gear; and
a second clutch configured to selectively fix the third idle gear to the second idle shaft.

6. The auxiliary driving apparatus of claim 5, wherein the second clutch comprises a dog clutch provided between a second clutch dog fixed to the second idle shaft and a hub of the third idle gear.

7. The auxiliary driving apparatus of claim 5, wherein the second clutch comprises a wet-type clutch provided between the second idle shaft and the third idle gear.

8. The auxiliary driving apparatus of claim 1, wherein the second speed reducing part includes:
a second input gear fixed to the auxiliary motor shaft;
a third idle gear fixed to the second idle shaft and externally engaged with the second input gear;
a fourth idle gear which is fixed to the second idle shaft and externally engages an output gear which is rotatably arranged on the output shaft; and
a second clutch configured to selectively fix the output gear to the output shaft.

9. The auxiliary driving apparatus of claim 8, wherein the second clutch comprises a dog clutch provided between a second clutch dog fixed to the output shaft and a hub of the output gear.

10. The auxiliary driving apparatus of claim 8, wherein the second clutch comprises a wet-type clutch provided between the output shaft and the output gear.

11. The auxiliary driving apparatus of claim 1, wherein the front wheel transfer is a transfer shaft or a propeller shaft.

12. The auxiliary driving apparatus of claim 1, wherein:
in a two-wheel drive (2WD) electric vehicle (EV) mode, a power delivery path of the second speed reducing part, through which the motor torque of the auxiliary motor is transmitted to a front wheel drive shaft, is blocked; and
in a 2WD series mode, a power delivery path of the first speed reducing part, through which the engine torque of the engine is transmitted to the auxiliary motor, is connected.

13. The auxiliary driving apparatus of claim 1, wherein, in a 4WD electric vehicle (EV) mode, a power delivery path of the second speed reducing part, through which the motor torque of the auxiliary motor is transmitted to a front wheel drive shaft, is connected.

14. An auxiliary driving apparatus of a four-wheel drive (4WD) hybrid electric vehicle, of which a first motor applied to a rear wheel side is a main driving source, the auxiliary driving apparatus comprising:
an engine placed in longitudinal direction on a front wheel side;
an auxiliary motor which is arranged in a longitudinal direction on the front wheel side and has an auxiliary motor shaft formed as a hollow shaft and is arranged to overlap an engine output shaft of the engine without rotation interference;
first and second idle shafts arranged parallel to the engine output shaft;
an output shaft arranged parallel to the second idle shaft and having power connected to an auxiliary differential via a front wheel transfer;
a first input gear fixed to the engine output shaft;
a second input gear fixed to the auxiliary motor shaft;
a first idle gear rotatably positioned on the first idle shaft, selectively connected to the first idle shaft via a first clutch, and externally engaged with the first input gear;
a second idle gear fixed to the first idle shaft and externally engaged with the second input gear;
a third idle gear rotatably disposed on the second idle shaft and externally engaged with the second input gear;
a fourth idle gear fixed to the second idle shaft; and
an output gear fixed to the output shaft and externally engaged with the fourth idle gear.

15. The auxiliary driving apparatus of claim 14, wherein the first clutch comprises a dog clutch provided between a first clutch dog fixed to the first idle shaft and a hub of the first idle gear.

16. The auxiliary driving apparatus of claim 14, wherein the first clutch comprises a wet-type clutch provided between the first idle shaft and the first idle gear.

17. The auxiliary driving apparatus of claim 14, further comprising a second clutch, wherein the second clutch comprises a dog clutch provided between a second clutch dog fixed to the second idle shaft and a hub of the third idle gear.

18. The auxiliary driving apparatus of claim 14, further comprising a second clutch, wherein the second clutch comprises a wet-type clutch provided between the second idle shaft and the third idle gear.

19. An auxiliary driving apparatus of a four-wheel drive (4WD) hybrid electric vehicle, of which a first motor applied to a rear wheel side is a main driving source, the auxiliary driving apparatus comprising:
an engine placed in longitudinal direction on a front wheel side;
an auxiliary motor which is arranged in a longitudinal direction on the front wheel side and has an auxiliary motor shaft formed as a hollow shaft and is arranged to overlap an engine output shaft of the engine without rotation interference;
first, second idle shafts arranged parallel to the engine output shaft;
an output shaft arranged parallel to the second idle shaft and having power connected to an auxiliary differential via a front wheel transfer;
a first input gear fixed to the engine output shaft;
a second input gear fixed to the auxiliary motor shaft;
a first idle gear rotatably positioned on the first idle shaft, selectively connected to the idle first shaft via a first clutch, and externally engaged with the first input gear;
a second idle gear fixed to the first idle shaft and externally engaged with the second input gear;
a third idle gear fixed to the second idle shaft and externally engaged with the second input gear;
a fourth idle gear fixed to the second idle shaft; and
an output gear rotatably disposed on the output shaft, selectively connected to the output shaft via a second clutch, and externally engaged with the fourth idle gear.

20. The auxiliary driving apparatus of claim 19, wherein the first clutch comprises a dog clutch provided between a first clutch dog fixed to the first idle shaft and a hub of the first idle gear.

21. The auxiliary driving apparatus of claim 19, wherein the first clutch comprises a wet-type clutch provided between the first idle shaft and the first idle gear.

22. The auxiliary driving apparatus of claim 19, wherein the second clutch comprises a dog clutch provided between a second clutch dog fixed to the output shaft and a hub of the output gear.

23. The auxiliary driving apparatus of claim 19, wherein the second clutch comprises a wet-type clutch provided between the output shaft and the output gear.
